(19) United States
(12) Patent Application Publication
(10) Pub. No.: US 2012/0123798 A1
(43) Pub. Date: May 17, 2012

(54) Health Care Financing Systems And Methods For Determination Of The Patient Specific Prospective Lump Sum Payment For An Episode Of Care Arising From An Insurable Event

(76) Inventor: John A. Lanzalotti, Williamsburg, VA (US)

(21) Appl. No.: 12/945,817

(22) Filed: Nov. 12, 2010

(51) Int. Cl. G06Q 50/00; G06Q 90/00; G06Q 10/00

(52) U.S. Cl. 705/3; 705/500

(57) ABSTRACT

This invention includes a health savings and financial application that analyzes an electronic medical record with patient data and with protocol and complexity data to determine if there is a new insurable event. If no, then the patient pays for discretionary care. However, if there is a nondiscretionary insurable event, then the medical record is used to relate the actual severity of the primary morbidity, co-morbidities, specific diagnosis and treatment, and local market factors matched with the complexity levels developed by specialists and matched for the subject patient to create an appropriate protocol at the appropriate complexity level by a matching algorithm. This match is communicated to the insurer or a healthcare manager and triggers payment by the selected complexity level of a particular protocol as a lump sum into the patient's health savings account. This lump sum payment represents an appropriate budget that enables the patient to pay all anticipated expenses arising from that insurable event or events directly to the providers, hospitals, and pharmacies of his choice.

### COPENDING APPLICATIONS

This application is a continuation-in-part and claims priority benefit of co-pending U.S. patent application Ser. No. 11/518,432 filed Sep. 11, 2006, titled “HEALTH CARE FINANCING” having John A. Lanzalotti as inventor, which is incorporated herein by reference as if set forth in full below, and which claims priority benefit of U.S. Provisional Application No. 60/715,569 filed Sep. 12, 2005 titled “HEALTH CARE FINANCING” having John A. Lanzalotti as inventor, which is incorporated by reference as if set forth in full below.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

I. Field

The invention relates to health care information and/or financial systems.

II. Background

Health Care costs and prices are currently increasing at an unsustainable rate. This inflation is a function of health care finance and delivery, specifically health insurance design, including the method of a physician filing a claim that results in third party payment and procedure-driven delivery. In turn, the current health insurance design results in attempts at opaque and ineffective regulation.

Current health care reimbursement processes have arbitrary incentives that allow the physician to use rules and loopholes to unilaterally benefit (referred to as “gaming the system”) to increase reimbursements beyond appropriate levels.

In order to eliminate inappropriate third party payment, it is necessary to establish prospective payment methods that match the condition of a particular patient and that cover the patient's episode of care. That is, the current design needs to eliminate individual, unrelated, and uncoordinated procedures that are inaccurately used in third party payment procedure driven finance systems. Accordingly, the patient use co-ordinated “prospective payment” assets to directly pay for medical care related to the insurable event.

To date, the only known prospective payment system is Capitation. Capitation is unsatisfactory for several reasons. It pays under market value, and is based only on the number patients contracted to a particular insurance payer. It does not give the provider an appropriate amount of money to pay for all anticipated expenses arising from an insurable event that requires a particular episode of care. Capitation does not take into consideration the severity of a particular patient's illness or the appropriateness of their care.

### SUMMARY

In an attempt to stop or otherwise minimize health care inflation, this invention proposes new business methods and systems for insurance payers and providers who create a prospective global budget in the form of a lump sum that represents a global budget paid to a patient's tax favored health care savings and spending account to be used by a patient to directly pay at fair market value all anticipated expenses arising from an insurable event to replace third party payment to providers by the insurance payer. This prospective payment will not require a doctor generated claim, removing the potential opportunity for a provider to commit fraud associated with collection during the claim process.

According to some of the exemplary embodiments, the present invention features a computerized process that allows a health care provider to notify the insurance payer and provides a means for a computer device to validate that an insurable event has occurred in a given patient without being able to use the rules and loopholes of our current finance system that uses a claim form to benefit unilaterally (referred to herein as “gaming the system”) to increase payment beyond appropriate levels, thus preventing fraud. It also features a computerized process of payment to the patient's expanded health care savings and spending account with an appropriate amount of money determined by the patient's complexity level of the insurable event.

This invention includes a software application running via a processor of a computer used by the physician. The physician inputs the patient's history and physical and other data of an electronic medical record (EMR), and the application extracts severity information concerning the patient's primary morbidity and the presence of any co-morbidities as well as other distinguishing features about the patient. The application matches data in the EMR to an appropriate protocol and complexity level of a particular insurable event or events.

As used herein, the term “insurable event” is a medical diagnosis or condition that is contracted by an insurance company to be paid when that event occurs.

As used herein, the term “protocol” is defined as “the primary morbidity for which the patient is insured.” And, as used herein the term “complexity level” is defined as “increasing morbidity and its treatment associated with the insurable event and the presence or absence of any co-morbidity and its treatment associated with the particular protocol.” Each established protocol (i.e., a diagnosis or condition representing the primary morbidity) is comprised of several complexity levels. Each complexity level represents increasing morbidity associated with the insurable event and the presence or absence of any co-morbidity associated with that particular protocol. These protocols and complexity levels have been developed by physicians from every medical specialty using historical data accumulated and analyzed over the last five years. These protocols and complexity levels take into account medical, pharmaceutical and hospital experience concerning diagnosis, treatment, cost of such treatment, and actuarial data. Each complexity level is associated with a relative value scale number that represents the relative value of each complexity level based on the necessary care required to treat the patient with that severity of disease represented by that complexity of the insurable event. For example, the sicker the patient, the more money the patient likely needs to pay his medical bills. Because health care is primarily a local market phenomenon, the relative value scale number is then multiplied by a factor λ that floats with known local market-related components to determine an actual financial value (e.g., dollar amount). Once determined, the financial value is electronically transferred as a lump sum payment into the patient's Healthcare Savings Account (HSA).

According to exemplary embodiments, the lump sum payment represents a global budget for the patient to pay all anticipated expenses arising from the insurable event at fair market value. Lump sum payment of the global budget provides the patient with enough money to pay for all anticipated, reimbursable health care expenses associated with treatment of a given medical condition (e.g., doctor bills, hospital bills, pharmaceutical bills, laboratory bills, physical therapy bills, surgery bills, and bills for any other associated healthcare service or treatment). The lump sum payment of the global budget is determined by protocol and complexity level and appropriate course of treatment for a given condition. This insurance payment does not require a co-payment or deductible payment from the patient since insured events are non-discretionary, price insensitive, and involve high-value care. After the lump sum is deposited into the HSA, the patient can use assets of the HSA to pay for healthcare related services associated with the protocol and complexity of the insurable event. For example, the patient may use a debit card, a smart card, a communications device (e.g., cell phone, iPod, etc.) or other electronic payment system (e.g., key fob with biometrics sensor and integrated payment components) to pay for all health care goods and services required to treat the condition.

The information concerning the complexity level in the computer of the physician is transformed into an electronic signal which is then sent to the insurance company of the patient where it is matched to the appropriate protocol at the appropriate complexity level by a matching algorithm. The match triggers the payment indicated by the selected complexity level of a particular protocol and transmits the payment as a lump sum into the patient's expanded and reformed health care savings account. This lump sum payment represents an appropriate budget that enables the patient to pay all anticipated expenses arising from that insurable event or events directly to the providers, hospitals, technicians, pharmacies, and other healthcare providers with an electronic medical debit card (or communications device having a payment interface) that is encrypted or otherwise electronically secured to comply with federal, state, local and other applicable laws governing payment of bills and communications of medical information (e.g., HIPPA, etc.).

According to some of the embodiments, the methods and systems generate an appropriate prospective payment when there is an insurable event. Such advance, lump payment makes third party payment unnecessary and eliminates health care delivery drivers that have historically caused rapid inflation of costs.

This invention allows a physician to verify and validate an insurable event without having to file a claim form. This invention allows physician-verification that a particular insurable event has occurred and deters fraud by preventing the physician from being able to use the rules and loopholes of the current finance system to increase payment beyond appropriate levels, thus preventing fraud.

This invention removes the poor incentives that exist in our current health care financing and delivery designs that contribute to health care cost inflation. It replaces them with good incentives with checks and balances to provide high quality care, at fair market prices, and expands patient choice, while eliminating heath care cost inflation. This invention allows the doctor freedom to practice medicine, i.e., to diagnose and treat the patient within the context of appropriate care without uniformity, and offer the best quality care at the lowest price without being constrained by top down bureaucratic control necessary with today's insurance design. It also allows the insurance payment to be closely matched to any individual patient's particular medical needs and eliminates the need for third party rationing and price controls to control medical cost inflation.

Other systems, methods, and/or products according to embodiments will be or become apparent to one with skill in the art upon review of the following drawings, and further description. It is intended that all such additional systems, methods, and/or products be included within this description, be within the scope of the present invention, and be protected by the accompanying claims.

### BRIEF DESCRIPTION OF THE DRAWINGS

The above and other exemplary embodiments, objects, uses, advantages, and novel features are more clearly understood by reference to the following description taken in connection with the accompanying figures wherein:

FIGS. 1 and 2 are flow diagrams illustrating the computerized operation of a health care finance system according to exemplary embodiments of this invention;

FIG. 3 is a diagram illustrating the interrelationship between protocol and complexity level and the amount of global budget made into a patient's health care savings and asset account according to exemplary embodiments of this invention;

FIG. 4 is a diagram illustrating the original establishment of protocols and complexity levels according to exemplary embodiments of this invention;

FIG. 5 is an exemplary system overview illustrating communications devices, communications networks, and operation of a Health Savings Application according to exemplary embodiments of the present invention.

FIG. 6 illustrates a block diagram of a communications device having a Health Savings Application according to exemplary embodiments of the present invention.

FIG. 7 illustrates a data record with exemplary, unfiltered data of the Health Savings Application in accordance with some of the embodiments of the present invention.

FIG. 8 is a diagram illustrating the development of the protocol and complexity level and the amount of the global budget made into a patient's health care savings and asset account according to exemplary embodiments of this invention.

FIG. 9 is a diagram illustrating use patient's health care savings and asset account to pay for selected treatment according to exemplary embodiments of this invention.

FIG. 10 is a flow chart illustrating exemplary methods or processes of this invention in accordance with some of the exemplary embodiments.

### DESCRIPTION

The word “exemplary” is used herein to mean “serving as an example, instance, or illustration.” Any configuration or design described herein as “exemplary” is not necessarily to be construed as preferred or advantageous over other configurations or designs. Furthermore, use of the words “present invention” is used herein to convey only some of the embodiments of the invention. For example, the word “present invention” would also include alternative embodiments and equivalent systems and components that one of ordinary skill in the art understands. An example is that the materials used for the exemplary embodiments may be made out of man-made materials, natural materials, and combinations thereof. A further example is that the apparatus or components of the apparatus may be manufactured by machine(s), human(s) and combinations thereof.

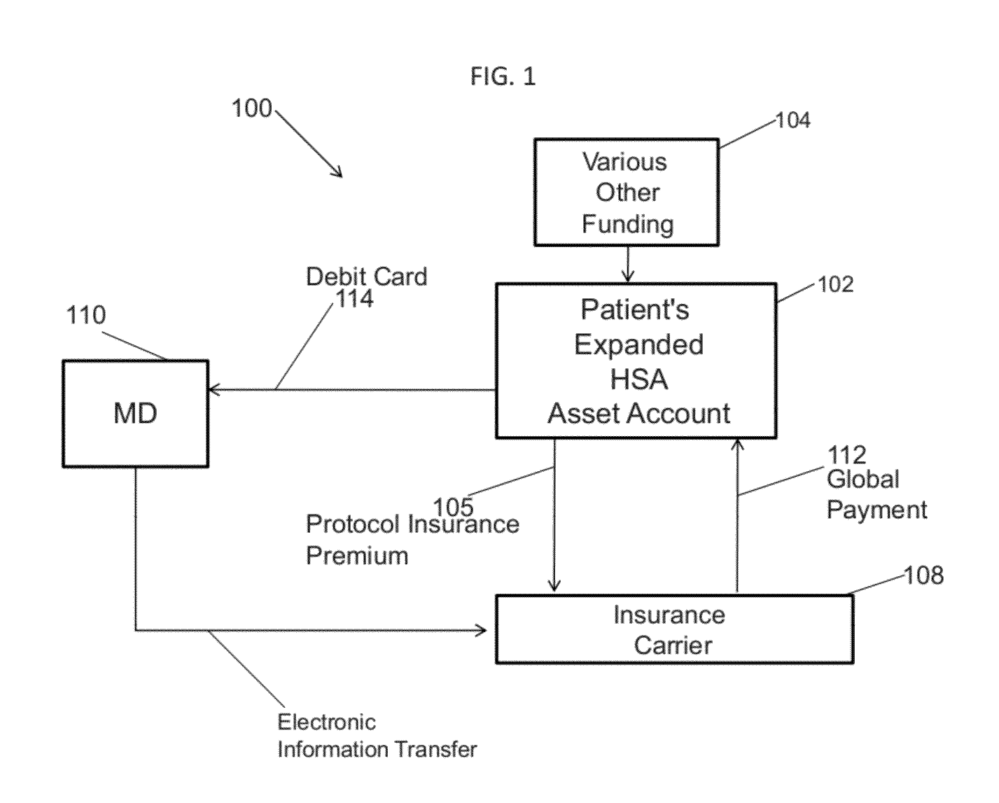

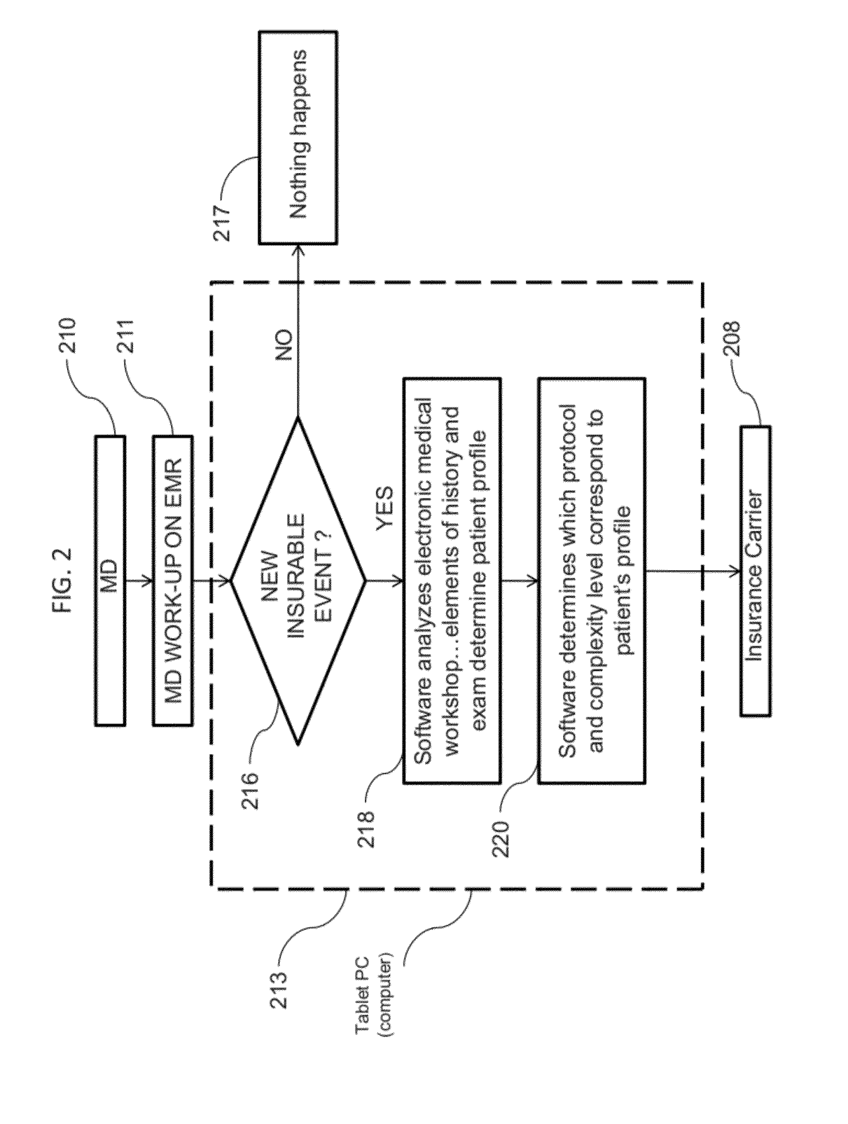

Within the descriptions of the figures, similar elements are provided similar names and reference numerals as those of the previous figure(s). Where a later figure utilizes the same element or a similar element in a different context or with different functionality, the element is provided a different leading numeral representative of the figure number (e.g., 1xx for FIGS. 1 and 2xx for FIG. 2). The specific numerals assigned to the elements are provided solely to aid in the description and not meant to imply any limitations (structural or functional) on the invention.

The functions of the various elements shown in the figures, including functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those skilled in the art further understand that the exemplary hardware, software, processes, methods, and/or operating systems described herein are for illustrative purposes and, thus, are not intended to be limited to any particular named manufacturer.

Some of the embodiments of the invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

A system 100 for financing and delivering health care according to the invention is illustrated in FIG. 1. According to the inventive system 100, an expanded personal and portable tax-free health care savings and asset account (HSA) 102 is established for every American individual or family using annual funding 104 from a variety of sources. These sources can include but are not limited to defined contributions from an employer; contributions from the owner of the account; tax credits; transfer payments from Medicaid or Medicare; E.I.T.C. funds; federal tax withholding from the working poor; charity; etc.

According to some estimates, twenty-five to thirty percent of the annual funding of the asset account 102 is used by the patient to pay an annual premium 106 for “protocol insurance” to any insurance carrier 108. The remainder of the funding rolls over from year to year and grows tax-free and can be used for discretionary care or for an initial visit (i.e., any diagnostic procedures done before any determination has been made by the doctor concerning diagnosis) health care spending, as well as retirement income by the beneficiaries of the account 102.

When a patient sees a doctor or other health care provider 110, the doctor or health care provider examines the patient and prepares a computerized medical workup that is used to determine a dollar amount to be electronically paid or otherwise transmitted directly into the patient's HSA by the insurance carrier 108. Software that is part of this invention evaluates the medical work-up and determines information about which established “protocol” and “complexity level” the patient's condition corresponds to, as described in greater detail below. An electronic transfer of this information from the provider's office computer (or alternate communications device) to the insurance carrier's computer (or alternate communications device) triggers a lump sum payment that represents a “global budget” 112 from the insurance carrier into the patient's HSA 112. The global budget provides the patient with enough money to be able to pay for all anticipated expenses (at fair market value) associated with an insurable event, e.g., doctor bills, hospital bills, pharmaceutical bills, surgery bills, and bills for any other necessary therapy, etc. The global budget made is determined by protocol and complexity level and course of treatment for a given condition. This insurance payment does not require a co-payment or deductible payment from the patient. The patient then accesses this global budget in his HSA W2 with a medical debit card 114 to pay for all health care goods and services required to treat the condition. Alternate state of the art payment mediums and devices may be used to access and make payments for the health care goods and services, such as for example, use of smartcard technology, encrypted payment software integrated into cellular phones, etc.

Creation of an electronic medical record (EMR) and analysis of that record, as well as determination of protocol and complexity level, is illustrated in more detail in FIG. 2. As illustrated, the physician or other health care provider 210 does a medical work-up on a computer 213, thus creating an electronic medical record 211, using drop-down menus to select appropriate and thorough descriptions of the patient's medical history, physical exam, lab and imaging results, and the physician's diagnosis and treatment plan. Software that is part of this invention interacts with the HSA application program used to create the work-up and analyzes this work-up and determines if there is a “new insurable event” 216. As used herein, the term “insurable event” is a medical diagnosis or condition that is contracted by the insurance company to be paid when that event occurs. If there is not a new insurable event, nothing happens 217 and the patient is responsible for paying the bill for that day's service (e.g., out of non-insurance-derived funds from the HSA in pre-tax dollars (money that remains in the account after the annual insurance premium is paid), (not out of pocket in post tax dollars as is done in the current system of insurance). If, on the other hand, there is a new insurable event, the HSA application determines the patient's medical profile from informational elements representing aspects of the patient's history; exam, lab, and imaging results; physician's diagnosis and plan of treatment; etc. in the electronic medical patient record 218. The HSA application then determines which established protocol and complexity level the patient's profile corresponds to, e.g., by using matching algorithms that trigger the transfer of the global budget into the HSA. This has some similarities to and replaces filing an insurance claim as in the current system.

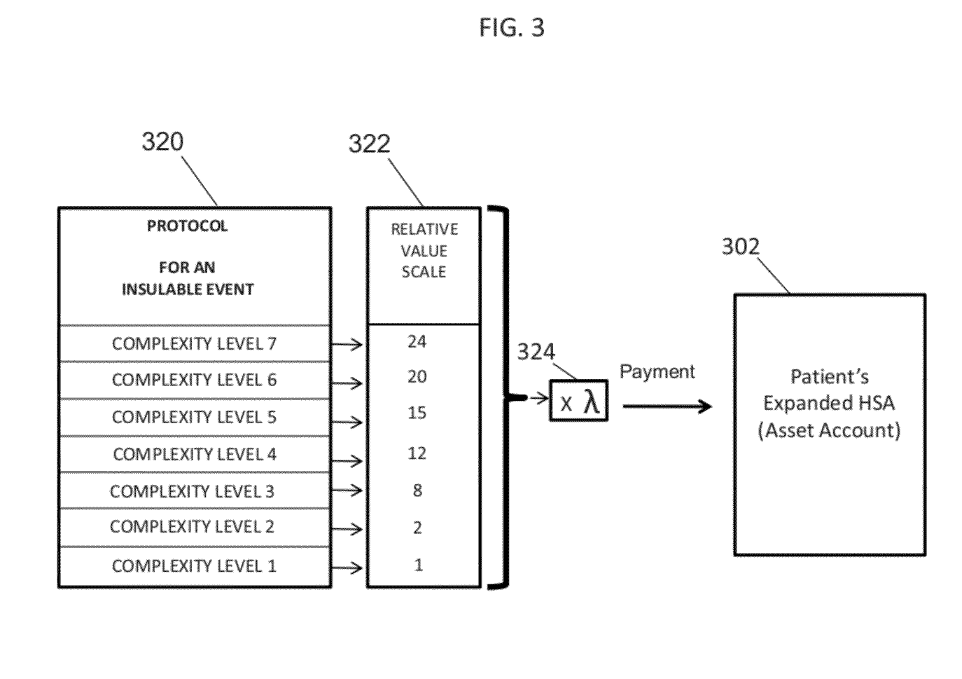

As noted above, the amount of the global budget for each insurable event is a function of or determined by the complexity level and protocol thereof as illustrated in FIG. 3. Each established protocol (a diagnosis or condition representing the primary morbidity) utilized by the HSA application is comprised of several complexity levels. Each complexity level represents increasing morbidity associated with the insurable event and the presence or absence of any co-morbidity associated with that particular protocol. Each complexity level is associated with a relative value scale number 322, which represents the relative value of each level of necessary care. FIG. 3 shows seven complexity levels: however, as one of ordinary skill in the art appreciates, the number of complexity levels may vary and depends on the particular diagnosis. In other words, the sicker the patient, the more money the patient likely needs to pay his medical bills. Because health care is primarily a local market phenomenon, the relative value scale number is then multiplied 124 by a factor λ that floats with known local market-related components to determine the actual dollar amount to be transferred as a global budget 312 into the patient's HSA 302.

By way of example, a patient diagnosed with acute gall bladder disease due to gall stones would correspond to a protocol for cholelithiases. Complexity level 1, for example, would be a single large gall stone with only occasional discomfort. The complexity level would pay for the doctor's visits to diagnose and treat the problem, the imaging to diagnose the problem, and the medication to control the occasional discomfort. A higher complexity level would pay enough to diagnose and treat the problem for example, the patient had multiple small stones, was diabetic, and had chronic obstructive pulmonary disease. In that case, the patient would need money for the doctor visits to diagnose, treat, and follow up from an in-hospital stay during which the patient would have surgery to remove the gallbladder. Medicine for infection and pain and intensive pulmonary therapy to prevent and treat atelectasis following surgery.

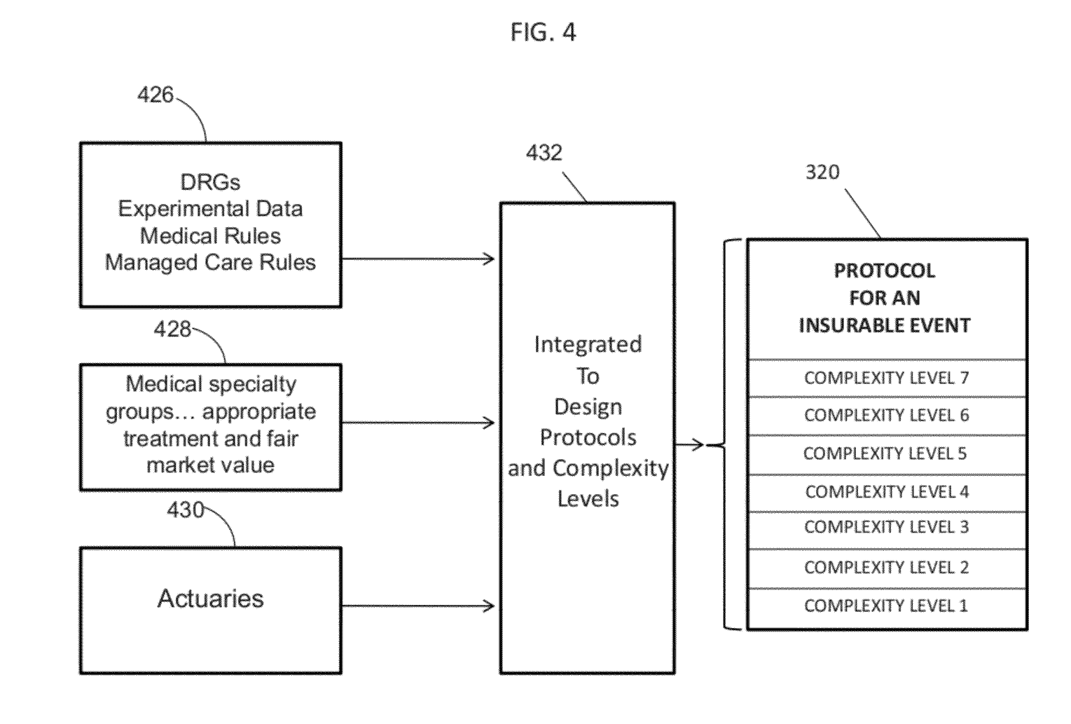

FIG. 4 illustrates how the protocols and complexity levels are originally set up according to the invention. Existing data concerning health care, finance and delivery, outcomes, diagnostic related groups (DRGs), and all Medicare and managed care rules as well as empirical and experiential data from the past thirty years of medical practice 426 is gathered and analyzed by a team of physicians from the various medical specialty groups. Theses specialists analyze this data in terms of appropriate treatment and fair market value for all diagnostic and treatment procedures 428. More specifically, selected doctors from each of the medical specialties societies construct the complexity levels by using the data to determine appropriate treatment for a given set of diagnostic signs and symptoms, laboratory and imaging parameters, severity of the primary morbidity and the presence or absence of co-morbidities, etc. In addition, medical and financial specialists determine appropriate fair market value for all doctor visits, lengths of hospital stays, appropriate medication, specialty consultations, surgeries, and other therapies. This information is then specifically integrated into the complexity levels of each individual protocol. This integrated data is then subjected to an actuarial analysis 430 to determine the relative value of the payments assigned to each complexity level as well as the dollar amounts to be paid.

In accordance with some of the embodiments, the present invention includes at least one web-enabled and GPS-enabled mobile device such as a cellular phone, satellite phone, smart phone, iPhone, etc. configured to communicate with various websites on the World Wide Web (WWW). The various websites may include one or more of databases configured to allow a patient to access and make payments to medical service providers over the WWW. In the exemplary embodiment, the mobile device should also include or be compatible with MP3 functionality (or other evolving comparable technology such as MP4 or MP5). Other hand-held devices that include or configured to include GPS applications, web-enabled and MP3 functionality may be used.

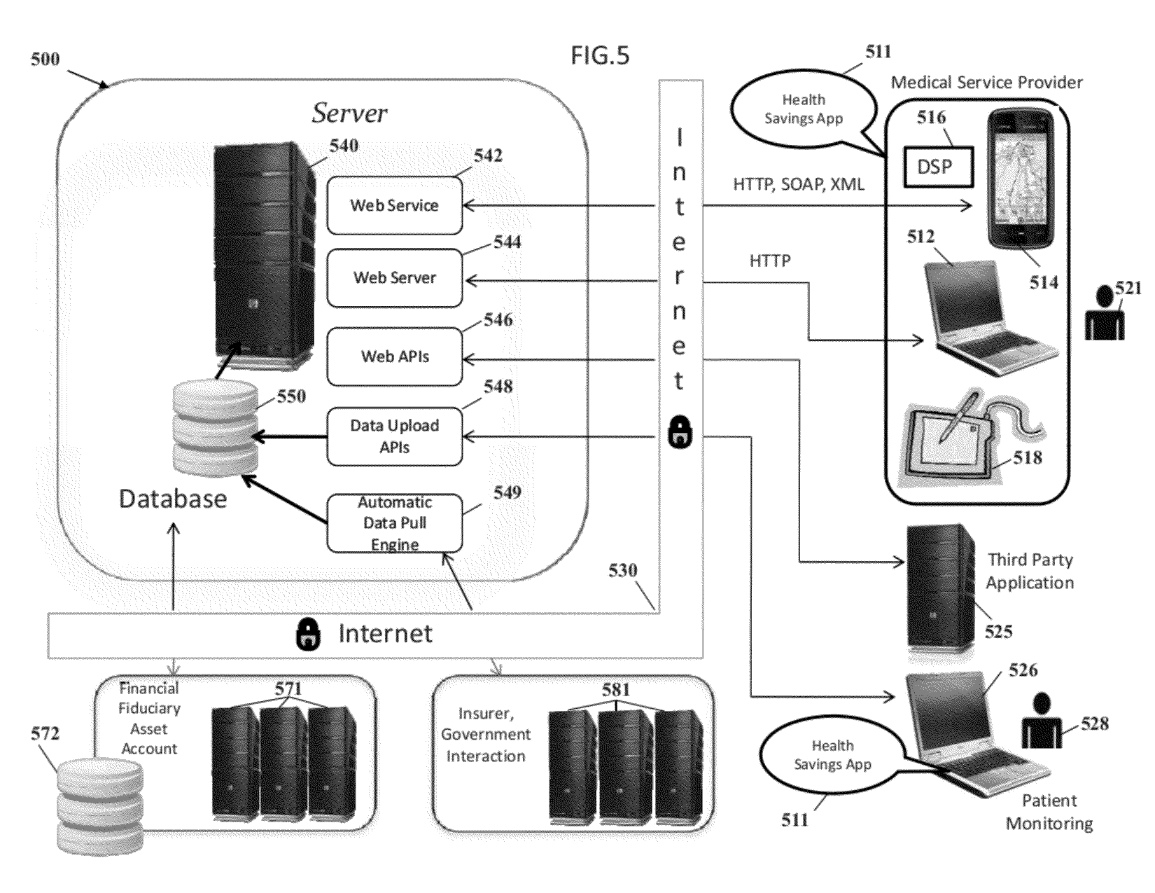

FIG. 5 illustrates an operating system 500 in accordance with some embodiments of the present invention. The system includes one or more mobile devices in secure communications (wired or wireless) 530 with a healthcare financial and savings website or some other networked dataserver 540 having a database 550 or collection of HSA records and a Health Savings Application 511. The mobile devices are shown as a handheld tablet 518, a laptop computer 512, a cellular phone having integrated GPS and MP4 functionality 514, and any device with a digital signal processor 516. The devices and system components communicate using a web service 542, a web server 544, web-based APIs 546, data upload APIs 548, and others.

The mobile device is configured to communicate with the healthcare financial and savings website using the WWW. The user may communicate with the healthcare financial and savings website via another device and transfer music files to the mobile device.

The mobile device or some other computing device may communicate with the website via the World Wide Web (WWW), Internet 530 or Intranet. The communication medium may be compatible with WiFi communications, IEEE 802.11 communications, 2 G, 2.5 G, 3G, 4G, XDSL, DSL, etc. Alternatively, the mobile device may communicate with the Health Savings Application 511 via the Public Switch Telephone Network (PSTN) or via a satellite communications network.

The system 500 is configured to allow web-enabled devices (laptops, personal computers or the like) to communicate with the WWW to access, analyze, identify insurable events, make payments from the HSA account to selected health care specialists, access sources of remote data, update complexity and protocol information, and store updated data. The web-enabled device allows the patient to have near real time valuations of his HSA account and show such information as (1) financial information associated with the global budget (e.g., payment amounts, deposit amounts, discretionary versus nondiscretionary payments, transfers to other HSA accounts, tax data, compliance with government reporting or other regulations (if applicable), etc.); (2) diagnosis and treatment information including access to medical and health care records; (3) HSA performance (e.g., interest earned), (4) easily track payments and charges to selected healthcare providers; (5) database to healthcare providers and facilities for selection of care; (6) interface with insurance or other entities providing financial assets for the HSA; (7) up to date data for compliance or interfacing with government regulation and requirements; and (8) access to third party applications to push and receive data associated with patients (e.g., applications enabling a patient to view x-rays, applications that allow for patient monitoring (e.g., cell phone applications for monitoring patient information such as blood sugar readings, weight, heart rhythms, etc.)).

The patient may download medical records, labs, x-rays, and other information to his communications device, in order to allow the patient data when there is a loss of cellular service or wireless data connection.

The system is configured to operate with wired or wireless devices. The devices may include a cellular phone, a terminal, personal computer (PC), a wirelessly-equipped personal digital assistant (PDA), a wireless communications device, a laptop computer. The wireless communications may be a Code Division Multiple Access (CDMA) system, a Global System for Mobile Communications (GSM) system, satellite communications, cellular communication, mobile communications, or some other system.

The healthcare financial and savings website and other websites comprise a web-based platform configured to execute a set of programs to interface with the devices, computers, and/or through the WWW. The web-based platform includes one or more processors, computers, servers to execute the set of programs for carrying out access to the website, set up and store user information, or operations to perform healthcare financial and savings services.

The mobile device is configured with a Health Savings Application 511. The system is configured to allow mobile and other communication devices to install the Health Savings Application 511 and receive updates via the WWW. The Health Savings Application 511 is configured to provide valuations of a user's HSA account and to access and provide a variety of information, such as (1) financial information associated with the global budget (e.g., payment amounts, deposit amounts, discretionary versus nondiscretionary payments, transfers to other HSA accounts, tax data, compliance with government reporting or other regulations (if applicable), etc.); (2) diagnosis and treatment information including access to medical and health care records; (3) HSA performance (e.g., interest earned), (4) easily track payments and charges to selected healthcare providers; (5) database to healthcare providers and facilities for selection of care; (6) interface with insurance or other entities providing financial assets for the HSA; (7) up to date data for compliance or interfacing with government regulation and requirements; and (8) access to third party applications to push and receive data associated with patients (e.g., applications enabling a patient to view x-rays, applications that allow for patient monitoring (e.g., cell phone applications for monitoring patient information such as blood sugar readings, weight, heart rhythms, etc.)). According to some embodiments the Health Savings application 511 uses location information of the communications device within a selected radius of the current location or projected route of the mobile device to suggest selected local health care providers or treatment facilities.

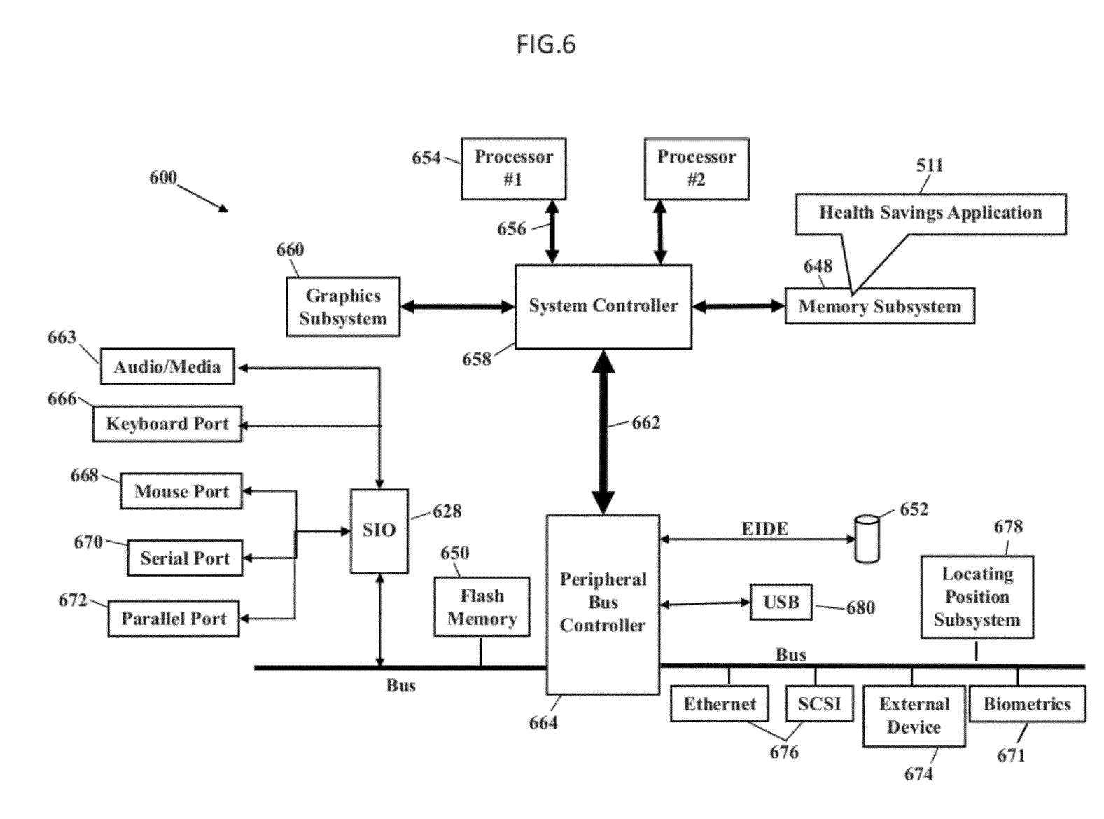

FIG. 6 is a block diagram showing the Health Savings Application 511 residing in a communications system 600 and/or smart phone system. The Health Savings Application 511 operates within a system memory device. The Health Savings Application 511, for example, is shown residing in a memory subsystem 648. The Health Savings Application 511, however, could also reside in flash memory 650 or peripheral storage device 652. The computer system also has one or more central processors 654 executing an operating system. The operating system, as is well known, has a set of instructions that control the internal functions of the computer system. A system bus 656 communicates signals, such as data signals, control signals, and address signals, between the central processor and a system controller 658 (typically called a “Northbridge”). The system controller provides a bridging function between the one or more central processors, a graphics subsystem 660, the memory subsystem, and a PCI (Peripheral Controller Interface) bus 662. The PCI bus is controlled by a Peripheral Bus Controller 664. The Peripheral Bus Controller (typically called a “Southbridge”) is an integrated circuit that serves as an input/output hub for various peripheral ports. These peripheral ports could include, for example, a keyboard port 666, a mouse port 668, a serial port 170 and/or a parallel port 672 for a video display unit, one or more external device ports 674 (e.g., biometrics subsystem 671 for verifying identifying information of a user), and networking ports 676 (such as SCSI or Ethernet). The Peripheral Bus Controller could also include an audio subsystem 663.

The system memory device (shown as memory subsystem, flash memory, or peripheral storage device) contains the Health Savings application 511 program. The Health Savings application 511 program cooperates with the operating system and with a video display unit (via the serial port and/or the parallel port) to provide a Graphical Customer Interface (GUI) and/or an audio interfaces via the audio/media subsystem 663. The Graphical Customer Interface provides a convenient visual and/or audible interface with the customer or user of the device 600. As is apparent to those skilled in the art, the selection and arrangement of data may be programmed over a variety of alternate mediums, such as, for example, a voice-activated menu prompt, an interactive session with an telecommunications network administrator, and the like.

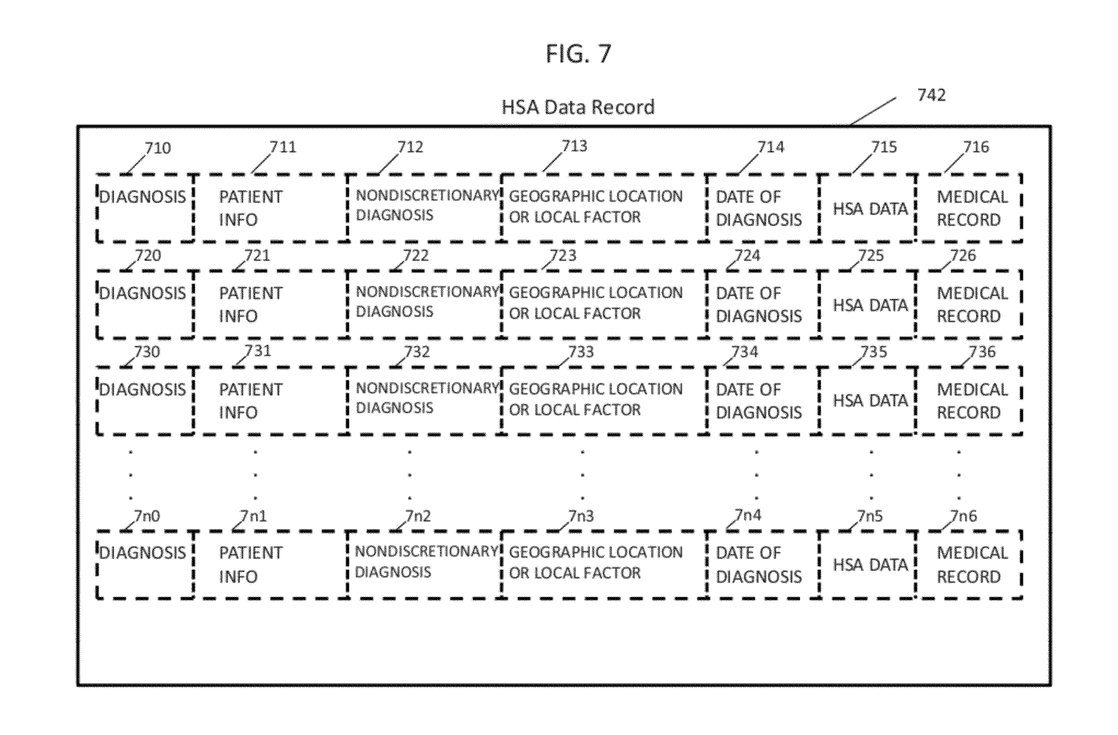

The Health Savings application 511 provides a convenient user interface for a variety of users—patients, health care providers, insurers, government entities, and other authorized third parties. These users may access selected data that includes the HSA records of FIG. 7. Such data 742 may include a variety of records (1 through n) that include diagnosis data 710, patient information 711, nondiscretionary diagnosis data 712 (and discretionary data (not shown)), geographic or local factor information 713, dates associated with diagnosis or treatment 714, other HSA financial and performance data 715, and/or other data in the patient's medical record including compliance and reporting information. While FIG. 7 illustrates an exemplary HSA data record 742, this invention includes data typically associated with health care cost drivers, and thus, such drivers may be considered when developing the protocol and complexity level of a diagnosis associated with a global budget for an insurable event. Below Tables 1 through 23 provide additional information on each of these health care cost drivers including (1) a brief description, (2) how a driver is currently used, (3) deficiencies, inaccuracies and problems with this driver, and advantages of eliminating this driver with this invention.

TABLE 1
Health Care Cost Driver Comparison
Moral hazard (reversible)

| | |
|---|---|
| Title | Moral hazard (reversible) |
| Brief Description | Individuals use services the cost of which is greater |
| | than their benefit. |
| How Driver is | Currently, insurance is designed to cover |
| Currently Used | discretionary and price-sensitive events. This is an |
| | inefficient incentive stemming from the government |
| | in the form of Medicare and Medicaid and private |
| | sector insurance carriers in their design of insurance |
| | financing. Patients do not have a financial incentive |
| | to remain healthy, thereby increasing risk. Currently, |
| | insurance requires co-payments and deductibles to |
| | offset this moral hazard. |
| Deficiencies, | People develop many habits and lifestyles that are not |
| inaccuracies and | healthy. They then develop many diseases that are |
| Problems with | caused by these habits which are then paid for by |
| This Driver | insurance, driving up the cost of treatment. Many |
| | Americans cannot afford deductibles and co- |
| | payments especially for non-discretionary and price |
| | insensitive events. |
| Advantages of | Patients do not have to pay expensive deductibles and |
| Eliminating this | co-payments especially for non-discretionary and |
| Driver with | price insensitive events. By separating non- |
| the AHCP | discretionary and price insensitive events from |
| | discretionary and price sensitive events, insurance |
| | can then lower risk and create a proper incentive for |
| | patients to remain health, changing to more healthy |
| | lifestyles and dropping unhealthy habits. By |
| | eliminating insurance for discretionary and price |
| | sensitive events, the premium for insurance drops |
| | considerably. The difference in premium payment |
| | from today's much more expensive payment can be |
| | kept in an asset savings account (reformed HSA) and |
| | used for events which are not insurable, discretionary |
| | or price sensitive. |

TABLE 2
Health Care Cost Driver Comparison
Under market physician and hospital reimbursement (reversible)

| | |
|---|---|
| Title | Under-market physician and hospital reimbursement |
| | (reversible) |
| Brief Description | Under-market physician and hospital reimbursement |
| | increases inefficiency by providing incentives for |
| | physician-induced demand for expensive, high-tech |
| | procedures. |
| How Driver is | Government and insurance reduce reimbursement to |
| Currently Used | under market payments in an attempt to control costs. |
| | This is a type of price control. Physicians have to |
| | maintain a certain income to pay for office overhead, |
| | malpractice insurance and to derive an income that is |
| | commensurate with their degree of professional |
| | responsibility. There is thus an incentive for the |
| | physician to inappropriately use expensive high tech |
| | diagnostic and treatment options to maintain this level |
| | of income. More patients also have to be seen in a |
| | given time period, reducing the time spent with each |
| | patient. More expensive and inclusive options are |
| | selected to accommodate this reduced time. |
| Deficiencies, | Price controls are ineffective at maintaining low costs. |
| inaccuracies and | More expensive, high-tech options cost more money |
| Problems with | and drive costs up. Less time spent with the patient |
| This Driver | lowers quality of care. |
| Advantages of | The patient will receive enough money for non- |
| Eliminating this | discretionary, price insensitive events to pay for all |
| Driver with | appropriate expenses arising from the insurable event |
| the AHCP | at full, fair market value. More doctors will be able to |
| | provide optimal visit time to each patient. Full fair |
| | market payment will eliminate the necessity of |
| | inappropriately using more expensive options when |
| | less expensive options suffice. The need for price |
| | controls can then be eliminated. |

TABLE 3
Health Care Cost Driver Comparison
Consumer demand for expensive high tech procedures (reversible)

| | |
|---|---|
| Title | Consumer demand for expensive high tech |
| | procedures (reversible) |
| Brief Description | Consumers demand easier and broader access to care |
| | and for service intensity. |
| How Driver is | Because of third party payment directly to providers, |
| Currently Used | the patients have no idea of the cost of various |
| | options. To the patient, one option is as good as the |
| | next regardless of cost. Therefore patients want the |
| | “best” option. |
| Deficiencies, | This driver results in over-consumption of needlessly |
| inaccuracies and | expensive options by patients. This drives costs up. |
| Problems with | |
| This Driver | |
| Advantages of | Results in the reduction of the inappropriate |
| Eliminating this | overconsumption of expensive options by patients. |
| Driver with | Patient demand takes cost into account, allowing for |
| the AHCP | more appropriate and optimal diagnostic and |
| | treatment options, lowering costs. The patient pays |
| | for medical care and knows the actual costs. The |
| | patient perceives the HSA assets as his “money” and |
| | not someone else's. Therefore, the patient spends the |
| | money more efficiently. |

TABLE 4
Health Care Cost Driver Comparison
Growing and aging population (not reversible)

| | |
|---|---|
| Title | Growing and aging population (not reversible) |
| Brief Description | More people consuming health care drives up the cost. |
| Advantages of | This driver cannot be reversed. |
| Eliminating this | |
| Driver with | |
| the AHCP | |

TABLE 5
Health Care Cost Driver Comparison
Patient overconsumption (reversible)

| | |
|---|---|
| Title | Patient overconsumption (reversible) |
| Brief Description | Third party payment provides incentives to patients to |
| | over-consume medical services and make |
| | inappropriate visits to the doctor. |
| How Driver is | Because of third party payment directly to providers, |
| Currently Used | the patient has no idea of the cost of various options. |
| | Patients make more visits to the doctor than is optimal |
| | because they are insured and not paying directly for |
| | their care. Since the insurance (“someone else” in the |
| | mind of the patient) is paying for their care, patients |
| | have no reason to question the appropriateness of their |
| | visits or limit the costs thereof. |
| Deficiencies, | This increases demand for limited resources, thereby |
| inaccuracies and | driving up costs. More consumption than is optimal |
| Problems with | costs more money. |
| This Driver | |
| Advantages of | Optimal use of medical services based on a more |
| Eliminating this | conscious interaction between patient and cost has the |
| Driver with | impact of lowering costs themselves. The patient pays |
| the AHCP | for medical care for which he knows the costs and |
| | directly paying for care with money that he perceives |
| | is his, making him more sensitive to the cost of those |
| | services. Therefore, the patient spends the money |
| | more efficiently, removing unnecessary spending and |
| | resource consumption. |

TABLE 6
Health Care Cost Driver Comparison
Physician over-utilization (reversible)

| | |
|---|---|
| Title | Physician over-utilization (reversible) |
| Brief Description | Third party payment provides incentives to physicians |
| | to over-utilize the most expensive procedures and |
| | options. |
| How Driver is | Because of third party payment directly to providers |
| Currently Used | the patients have no idea of the cost of various |
| | options. Patients make more visits to the doctor than |
| | is optimal because they are insured and not paying |
| | directly for their care. Since the insurance and not |
| | they themselves who are paying for their care, patients |
| | have no reason to question the appropriateness of their |
| | visits and the options chosen by their doctor. There is |
| | an incentive for the physician to inappropriately use |
| | expensive diagnostic and treatment options to |
| | maintain income. More expensive and inclusive |
| | options are selected. |
| Deficiencies, | This increases demand and, when the resources are |
| inaccuracies and | limited, drives costs up. Inappropriate use of |
| Problems with | expensive options costs more money. These high-tech |
| This Driver | options themselves cost more money and drive costs |
| | up. |
| Advantages of | The physician has a proper incentive to provide the |
| Eliminating this | patient with high quality care at the lowest price |
| Driver with | because he is under the restraints of a budget. The |
| the AHCP | more efficiently and cost-effectively he selects care |
| | for the patient, the more money the physician can |
| | make for himself. Patient-induced demand for |
| | inappropriately expensive options are eliminated, thus |
| | lowering costs. By offering the patient options within |
| | the context of appropriate care based on their price |
| | and value, competition between options is added at the |
| | doctor/patient level, thus driving costs down. |

TABLE 7
Health Care Cost Driver Comparison
Procedure-driven medicine (reversible)

| | |
|---|---|
| Title | Procedure-driven medicine (reversible) |
| Brief Description | Fee-for-procedure medicine and the costly |
| | infrastructure necessary to file claims and receive |
| | payment |
| How Driver is | The provider currently is paid by submitting a claim |
| Currently Used | to the insurance company listing the diagnosis and |
| | procedure code with modifier code. This has led to |
| | physicians treating disease episodically with a series |
| | of unrelated procedures which may or may not be |
| | optimal for that particular patient, often by different |
| | physicians who unaware of what the other physicians |
| | are doing. A large office staff is necessary to file |
| | claims and follow up with the insurance carriers when |
| | claims aren't paid in a timely manner. |
| Deficiencies, | By designing fee-for-procedure health delivery, |
| inaccuracies and | insurance, both public and private in the current |
| Problems with | paradigm, has created incentives in the delivery of |
| This Driver | health care that fragment that care instead of treating |
| | the patient most efficiently in a coordinated fashion. |
| | This inefficiency is not cost effective, and the cost of |
| | treating the patient rises. The large office staff |
| | necessary costs money and overhead costs are high. |
| Advantages of | By eliminating procedure-driven care, health care |
| Eliminating this | delivery is more efficient, thus lowering health care |
| Driver with | costs. By using the protocols in the AHCP, the patient |
| the AHCP | receives a budget that is appropriate to treat the |
| | patient's episode of care. A large office staff used |
| | exclusively for claim submission and retrieval can be |
| | eliminated, lowering costs for the physician and thus |
| | for his patients. |

TABLE 8
Health Care Cost Driver Comparison
Opaque administrative mechanisms of managed care (reversible)

| | |
|---|---|
| Title | Opaque administrative mechanisms of managed care |
| | (reversible) |
| Brief Description | Managed competition involves problems of |
| | information, coordination, and incentives in the supply |
| | of clinical services. |
| How Driver is | This provides limited consumer choice and provider |
| Currently Used | coordination. There is limited consumer cost sharing. |
| | Physician group practices work best in this system, |
| | and solo practitioners are discouraged with an |
| | emphasis on large physician and hospital |
| | organizations. There is physician credentialing by the |
| | carrier. It primarily uses price controls and rationing |
| | to control costs. Competition is based on cost alone. |
| Deficiencies, | Large bureaucracies require money which is taken |
| inaccuracies and | from patient care. This is inefficient and not cost- |
| Problems with | effective. Competition based on price alone results in |
| This Driver | poor choices and money wasted. Physician |
| | credentialing eliminates competent physicians from |
| | the available work force. This increases the work load |
| | and inefficiency of those physicians selected. This |
| | increase the possibility for error and needless |
| | repetition. This drives up the costs of care. Tight |
| | provider networks and increased consumer sharing |
| | drive up costs and threaten efficiency and delivery |
| | equity. Managed care has poor incentives to control |
| | costs. |
| Advantages of | Large bureaucracies are replaced with software using |
| Eliminating this | protocols and an automated process. The AHCP |
| Driver with | offers a more transparent, flexible and personal system |
| the AHCP | with no redundancy. This lowers costs and provides |
| | the proper incentives to both provider and patient. |
| | The AHCP introduces competition at the |
| | physician/patient level and provides optimum |
| | incentives to lower costs. |

TABLE 9
Health Care Cost Driver Comparison
Micromanagement of physicians (reversible)

| | |
|---|---|
| Title | Micromanagement of physicians (reversible) |
| Brief | The tendency for both private and federal insurance to |
| Description | micromanage providers is not cost effective and drives |
| | up costs in long run. |
| How Driver is | Large bureaucracies are necessary to micromanage |
| Currently Used | individual providers according to the needs of the |
| | insurance rather than those of the patient or physician. |
| | Only a two-tiered utilization management system is |
| | permitted. |
| Deficiencies, | Large bureaucracies cost money that can be better |
| inaccuracies and | used for patient care. The use of a mandatory two- |
| Problems with | tiered system leads to an inferior and more costly |
| This Driver | situation. |
| Advantages of | No bureaucracy is necessary. All costs associated |
| Eliminating this | with physician management can be eliminated. The |
| Driver with the | automated protocols are designed to provide each |
| AHCP | patient with the appropriate funds required by the |
| | insurable event in the most efficient and cost-effective |
| | way. |

TABLE 10
Health Care Cost Driver Comparison
Regulatory overgrowth (reversible)

| | |
|---|---|
| Title | Regulatory overgrowth (reversible) |
| Brief | Administrative costs and central organizational |
| Description | overgrowth as exhibited by federal government |
| | legislation/regulations. |
| How Driver is | Annually, $600 billion are spent on administration. |
| Currently Used | Layers of opaque regulation are used by the |
| | government to regulate the current market. With the |
| | current insurance design, administrative costs are now |
| | very high, though they were initially low. |
| Deficiencies, | The regulation is ineffective and expensive. |
| inaccuracies and | Administration costs of third party payment are high |
| Problems with | because of the incentives inherent in the design and |
| This Driver | the abuses that have occurred over the past forty years. |
| | Third party payment could not contain costs as our |
| | medical knowledge/technology has exploded over the |
| | past 50 years. |
| Advantages of | The protocols of the AHCP reduce administrative |
| Eliminating this | costs to less than 2%. |
| Driver with the | |
| AHCP | |

TABLE 11
Health Care Cost Driver Comparison
Cost shifting (reversible)

| | |
|---|---|
| Title | Cost shifting (reversible) |
| Brief Description | Cost shifting among payers; also from government |
| | payers to private sector purchasers. |
| How Driver is | All insurances pay under market value payments. |
| Currently Used | Hospitals shift their losses to people with insurance in |
| | the form of increased premiums, and to the taxpayer |
| | in the form of increased payroll and income tax. |
| Deficiencies, | Cost shifting subsidizes the elderly, the uninsured, the |
| inaccuracies and | poor, and those who are underinsured in the most |
| Problems with | expensive, least cost-effective and least efficient way, |
| This Driver | inflating the overall cost of health care. |
| Advantages of | Since all patients using the AHCP (or HAS) pay full, |
| Eliminating this | fair market value for their care, there is no cost |
| Driver with the | shifting, therefore cutting cost inflation. |
| AHCP | |

TABLE 12
Health Care Cost Driver Comparison
Longer, deeper insurance underwriting cycle (reversible)

| | |
|---|---|
| Title | Longer, deeper insurance underwriting cycle |
| | (reversible) |
| Brief Description | A longer and deeper insurance underwriting cycle; |
| | insurance entities raise premiums in order to restore |
| | their profitability: insurer premium “catch-up.” |
| How Driver is | The tendency to swing between profitable and |
| Currently Used | unprofitable periods over time is known as an |
| | insurance underwriting cycle. These cycles are |
| | unpredictable. This is because there is not enough |
| | data with a base of similar risks to accurately predict |
| | future risks and thereby minimize the effects of the |
| | cycle. The losses that result from this lack of data and |
| | risk minimization often force insurers to raise prices, |
| | thereby increasing costs. |
| Deficiencies, | The boom/bust cycle causes premium rates to inflate. |
| inaccuracies and | |
| Problems with | |
| This Driver | |
| Advantages of | The AHCP produces enough data with a stable base of |
| Eliminating this | similar risks to accurately predict claims, thereby |
| Driver with the | lowering costs. |
| AHCP | |

TABLE 13
Health Care Cost Driver Comparison
Inflated drug costs (reversible)

| | |
|---|---|
| Title | Inflated drug costs (reversible) |
| Brief Description | Escalating prescription drug costs and over-use. |
| How Driver is | The government/industrial complex currently gives |
| Currently Used | monopoly power to the drug industry, allowing the |
| | industry to raise profits through market manipulation. |
| Deficiencies, | This behavior drives up the cost of drugs. This cost is |
| inaccuracies and | then shifted to American citizens to make up for the |
| Problems with | shortfall due to foreign price controls. |
| This Driver | |
| Advantages of | AHCP institutes a free market that keeps any one |
| Eliminating this | provider or factor from having exorbitant power over |
| Driver with the | the health care market, thereby lowering costs. |
| AHCP | |

TABLE 14
Health Care Cost Driver Comparison
Provider negotiations (reversible)

| | |
|---|---|
| Title | Provider negotiations (reversible) |
| Brief Description | Provider negotiations with health plans for higher |
| | reimbursement. |
| How Driver is | Hospitals and physicians are suing insurance carriers |
| Currently Used | for higher reimbursement. |
| Deficiencies, | This activity drives up costs to offset losses elsewhere, |
| inaccuracies and | plus the cost of the ensuing legal fees. |
| Problems with | |
| This Driver | |
| Advantages of | All providers are paid at fair market value and do have |
| Eliminating this | an incentive to sue. |
| Driver with the | |
| AHCP | |

TABLE 15
Health Health Care Cost Driver Comparison
Over supply of hospital beds, high-tech equipment, and
specialists (reversible)

| | |
|---|---|
| Title | Over supply of hospital beds, high-tech equipment |
| | and specialists (reversible) |
| Brief Description | The oversupply of hospital beds, expensive equipment |
| | and specialists. |
| How Driver is | There is no free market to regulate these goods and |
| Currently Used | services, so hospitals pay for many more of these |
| | expensive commodities than is necessary. |
| Deficiencies, | This causes gross inefficiencies and cost-ineffective |
| inaccuracies and | management. |
| Problems with | |
| This Driver | |
| Advantages of | Goods and services are allocated in an efficient and |
| Eliminating this | cost-effective way, cutting out excess while still |
| Driver with the | meeting patient and physician needs. |
| AHCP | |

TABLE 16
Health Care Cost Driver Comparison
Volume of medical services (reversible)

| | |
|---|---|
| Title | Volume of medical services (reversible) |
| Brief Description | The volume of medical services provided for inpatient |
| | care. |
| How Driver is | There is no free market to regulate these goods and |
| Currently Used | services. |
| Deficiencies, | This causes gross inefficiencies and the least cost |
| inaccuracies and | effective management because the volume is |
| Problems with | needlessly high. |
| This Driver | |
| Advantages of | Goods and services are allocated in an efficient and |
| Eliminating this | cost effective way through cutting out unnecessary |
| Driver with the | medical services. |
| AHCP | |

TABLE 17
Health Care Cost Driver Comparison
Defensive medicine (reversible)

| | |
|---|---|
| Title | Defensive medicine (reversible) |
| Brief Description | Defensive medicine as used by physicians to protect |
| | against malpractice suits. |
| How Driver is | Physicians deviate from the most efficient and cost- |
| Currently Used | effective practices of medicine to doing more |
| | procedures in order to avoid the threat of lawsuit. |
| Deficiencies, | This unnecessarily drives up the cost of health care |
| inaccuracies and | |
| Problems with | |
| This Driver | |
| Advantages of | The AHCP has incentives for both the patient and |
| Eliminating this | physician to discuss their options, and the choice for |
| Driver with the | care is made cooperatively, decreasing physician |
| AHCP | liability. |

TABLE 18
Health Care Cost Driver Comparison
End of life care (reversible)

| | |
|---|---|
| Title | End of life care (reversible) |
| Brief Description | Excessive and inappropriate treatment at the end of |
| | life. |
| How Driver is | Third party payment by Medicare pays for all care no |
| Currently Used | matter how inappropriate. |
| Deficiencies, | This is inefficient and not cost effective and drives |
| inaccuracies and | costs up, also using up medical resources. |
| Problems with | |
| This Driver | |
| Advantages of | In the AHCP patients, cannot be rationed excess care |
| Eliminating this | by the government or insurance carriers. Only non- |
| Driver with the | discretionary and price insensitive events are insurable |
| AHCP | events, so patients are financially responsible for any |
| | excess care they desire. |

TABLE 19
Health Care Cost Driver Comparison
Medical price inflation (reversible)

| | |
|---|---|
| Title | Medical price inflation (reversible) |
| Brief Description | The medical price inflation which results from a |
| | dysfunctional market and economy. |
| How Driver is | Price insensitivity on behalf of consumers, lack of |
| Currently Used | competition, and technological complexity controls |
| | the cost of medical services. |
| Deficiencies, | This is inefficient and not cost effective and drives |
| inaccuracies and | costs up |
| Problems with | |
| This Driver | |
| Advantages of | In the AHCP there is a competitive free market where |
| Eliminating this | innovations are used only if they are efficient and cost |
| Driver with the | effective, and consumers make more informed, |
| AHCP | efficient choices. |

TABLE 20
Health Care Cost Driver Comparison
Poor-quality care (reversible)

| | |
|---|---|
| Title | Poor-quality care (reversible) |
| Brief Description | Poor-quality care including errors, overuse, misuse |
| | and under-use of health care services, including |
| | avoiding sick patients, lowering staff-to-patient ratios, |
| | and the denial of care by some insurers and health |
| | plans. |
| How Driver is | The use of third party payment, under market |
| Currently Used | payment, price controls and rationing lead to poor |
| | incentives. |
| Deficiencies, | Poor incentives translate into poor quality care. |
| inaccuracies and | |
| Problems with | |
| This Driver | |
| Advantages of | In the AHCP there is a competitive free market where |
| Eliminating this | negative incentives are eliminated by full, fair market |
| Driver with the | payment. |
| AHCP | |

TABLE 21
Health Care Cost Driver Comparison
State insurance mandates (reversible)

| | |
|---|---|
| Title | State insurance mandates (reversible) |
| Brief Description | State insurance mandates that guarantee benefits. |
| How Driver is | State mandates are all related to third party payment, |
| Currently Used | |
| Deficiencies, | This increases costs to insurance companies and raises |
| inaccuracies and | patient premiums. |
| Problems with | |
| This Driver | |
| Advantages of | The AHCP eliminates third party payment and there is |
| Eliminating this | no necessity for state mandates. |
| Driver with the | |
| AHCP | |

TABLE 22
Health Care Cost Driver Comparison
Solvency requirements (reversible)

| | |
|---|---|
| Title | Solvency requirements (reversible) |
| Brief Description | State solvency requirements oversee and require |
| | health plans' financial solvency. |
| How Driver is | Although these State solvencies were meant to benefit |
| Currently Used | consumers, they result in costs that are borne by |
| | insurers and are ultimately passed on to those |
| | consumers. |
| Deficiencies, | This increases costs to insurance companies and raises |
| inaccuracies and | patient premiums. |
| Problems with | |
| This Driver | |
| Advantages of | The AHCP creates a risk stabilized market for |
| Eliminating this | insurance which lessens the risk of insolvency. |
| Driver with the | |
| AHCP | |

TABLE 23
Health Care Cost Driver Comparison
Fraud and abuse (reversible)

| | |
|---|---|
| Title | Fraud and abuse (reversible) |
| Brief Description | Use of the rules and loopholes of our current finance |
| | system that uses a claim form to benefit unilaterally to |
| | increase payment beyond appropriate levels. |
| How Driver is | Physicians notify the insurance payer and validate the |
| Currently Used | fact that an insurable event has occurred in a given |
| | patient using the rules and loopholes of our current |
| | finance system that uses a claim form to benefit |
| | unilaterally to increase payment beyond appropriate |
| | levels. |
| Deficiencies, | This increases costs to insurance companies and raises |
| inaccuracies and | patient premiums. |
| Problems with | |
| This Driver | |
| Advantages of | Allows physician verification that a particular |
| Eliminating this | insurable event has occurred without the physician |
| Driver with the | being able to use the rules and loopholes of our |
| AHCP | current finance system to benefit unilaterally to |
| | increase payment beyond appropriate levels, thus |
| | preventing fraud. |

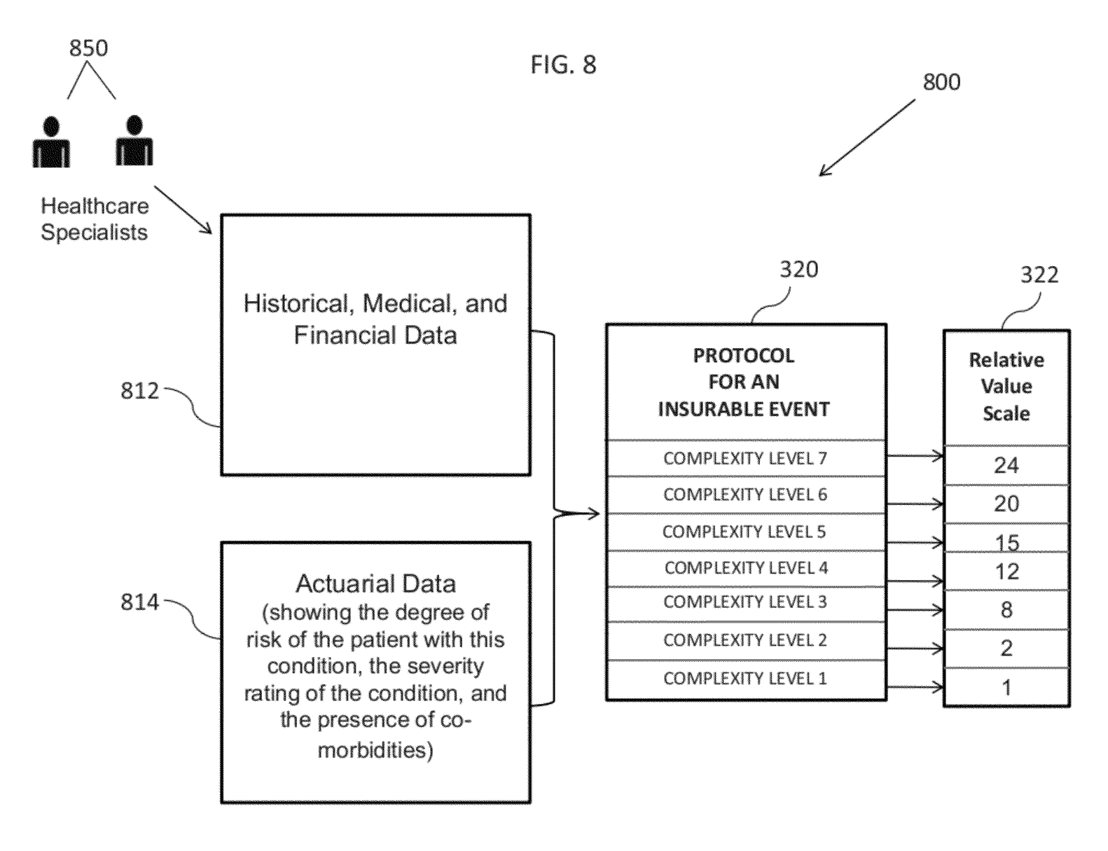

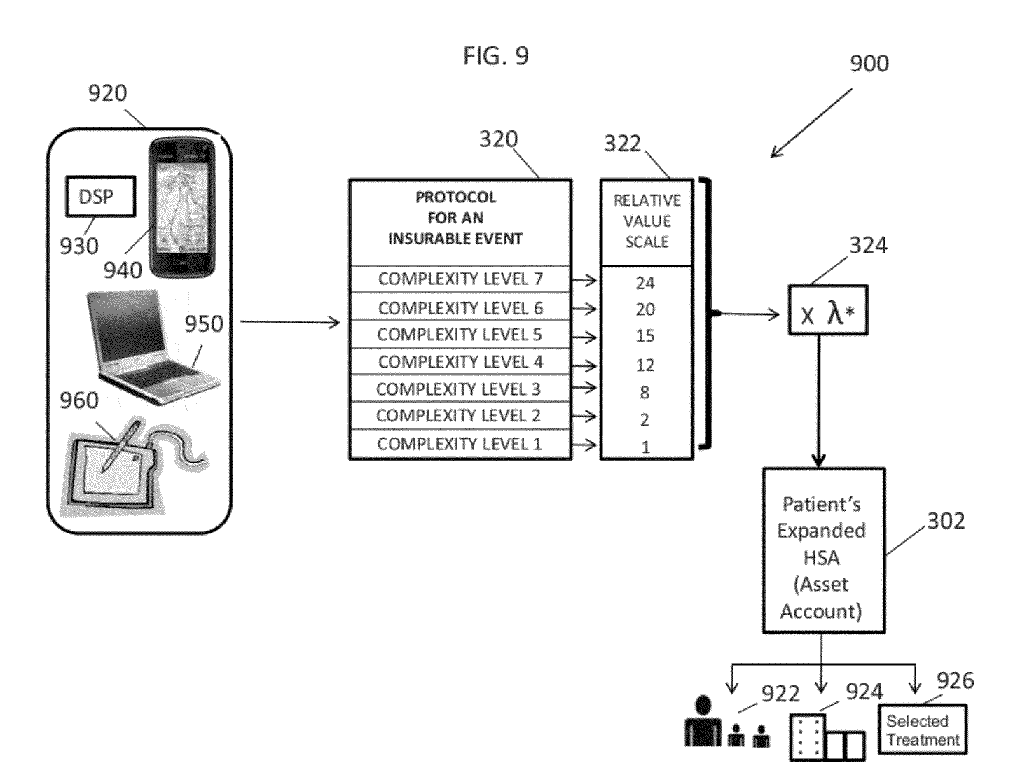

Referring now to FIGS. 8 and 9, this invention proposes a new business systems and methods to be used by insurance payers and providers to create a prospective payment in the form of a lump sum that represents a global budget paid to a patient's tax favored health care savings and spending (or HSA) account to be used by a patient to directly pay at fair market value all anticipated expenses arising from an insurable event to replace third party payment to providers by the insurance payer. This prospective payment does not require a healthcare provider to generate claim, removing the opportunity for the provider(s) to commit fraud in the conventional insurance reimbursement claim process. Moreover, this invention enables the patient to disburse the global budget to select providers and for selected treatment and promotes responsible spending.

According to FIG. 8, healthcare specialists 850 review historical medical and financial data 812 to quantify and establish and develop protocols for discretionary insurable events 320 that also incorporate actuarial data 814 associated with the degree of risk of the patient with this condition, the severity rating of the condition and the presence of co-morbidities. The protocols for an insurable event are assigned various complexity levels that translate to a relative value score 322.

Once created, these protocols can be used according to FIG. 9 to allow a healthcare provider to notify an insurance payer and validate that an insurable event has occurred in a given patient without being able to use the rules and loopholes of our current finance system. According to FIG. 9, a health care provider uses a communications device 920 shown as a tablet 960, a laptop computer, 950, a cellular or satellite phone 940 or any communications device having a digital signal processor (DSP) 930 to create an electronic medical record that is used to assign or otherwise match the appropriate protocol with complexity level 320 and associated relative value score 322. Thereafter, the diagnosis with the relative value score 322 is adjusted by a local market factor 324 to calculate whether there is a new insurable event, and if so, then to transfer a lump sum payment of the global budget into the patient's HSA 302. Thereafter, prospective payments are made by the patient to a selected health care provider 922, to a selected facility 924, and/or for selected treatment 926. If however, there is not a new insurable event, then the system 900 analyzes if the event is insurable and is associated with a previously diagnosed insurable event so that HSA assets 302 may be used to make a payment to the selected health care provider 922, to the selected facility 924, and/or for the selected treatment 926.

“Protocol and complexity level information” is not an established, preexisting term of art; to the contrary, it is terminology that is unique to the invention. Moreover, Applicant has acted as his own lexicographer and has explicitly defined or explained in the specification the not-yet-standardized terminology. Moreover, as used herein, an “insurable event” is a medical diagnosis or condition that is contracted by an insurer or other financial payer to be paid when an insurable or reimbursable event occurs. Furthermore, each established protocol (a diagnosis or condition representing the primary morbidity) in the present invention is comprised of several complexity levels. This is a severity rated and risk adjusted protocol. The degree of risk of the patient is tailored to the complexity levels of any given protocol. Each complexity level represents increasing morbidity associated with the insurable event and the presence or absence of any co-morbidity associated with that particular protocol. These protocols and complexity levels are developed by physicians and financial specialists (if needed) for every medical specialty using the degree of risk of the patient, data from the past five years of medical, pharmaceutical and hospital experience concerning diagnosis, appropriate treatment and the appropriate cost of such treatment integrated with actuarial data and incorporated into the source-code. Each complexity level is associated with a relative value scale number that represents the relative value of each complexity level based on the necessary care required to treat the patient with that severity of disease represented by that complexity of the insurable event. As discussed earlier, the sicker the patient, the more money the patient likely needs to pay his medical bills. Because health care is primarily a local market phenomenon, the relative value scale number is then multiplied by a factor λ that floats with known local market-related components to determine the actual dollar amount to be electronically transferred as a lump sum payment into the patient's expanded and reformed healthcare savings account.

Additionally, the invention introduces and is based in part on the concept of a lump sum payment representing a global budget with which the patient can pay all anticipated expenses arising from the insurable event at “fair market value.” The lump sum payment is a global budget that provides the patient with enough money to be able to pay for all anticipated expenses associated with treatment of a given medical condition, including, for example, doctor bills, hospital bills, pharmaceutical bills, surgery bills, and bills for any other necessary therapy. The lump sum payment is determined using the protocol and complexity level and appropriate course of treatment for a given condition. This insurance payment does not require a co-payment or deductible payment from the patient since insured events are nondiscretionary, price insensitive, and involve high value care. The patient then accesses this global budget in the form of a lump sum payment in his electronic healthcare savings account with a medical electronic debit card (or alternate payment mechanism) to pay for all health care goods and services required to treat the condition.

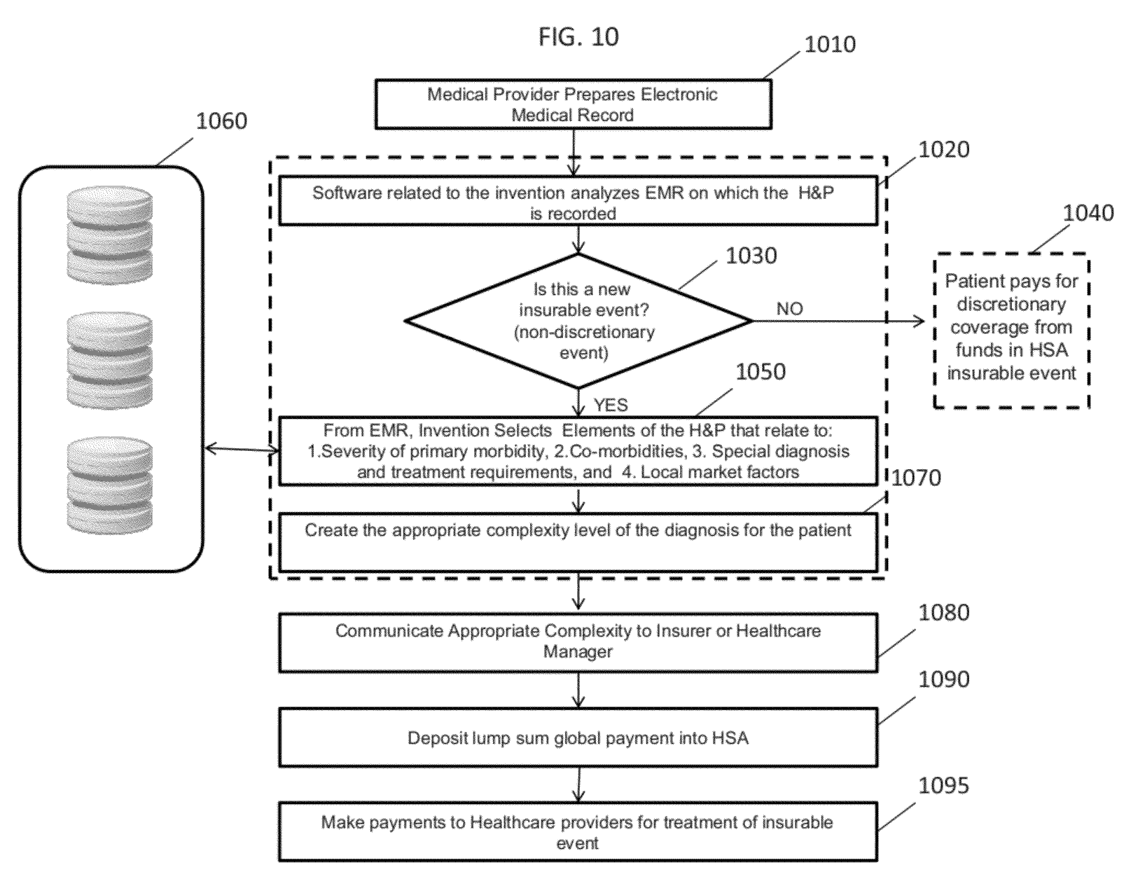

Referring now to the flow chart of FIG. 10, a health care provider prepares an electronic medical record 1010 that is sent or transmitted to or analyzed by a health savings and financial application 1020 that determines if there is a new insurable event 1030. If no, then the patient pays for discretionary coverage 1040. If there is a nondiscretionary insurable event, then the medical record is used to relate the severity of the primary morbidity, co-morbidities, specific diagnosis and treatment, and local market factors 1050 matched with the complexity levels developed by specialists 1060 and matched for the subject patient to create an appropriate protocol at the appropriate complexity level by a matching algorithm 1070. This match is communicated to the insurer or a healthcare manager 1080 and triggers payment by the selected complexity level of a particular protocol as a lump sum into the patient's expanded and reformed health care savings account 1090. This lump sum payment represents an appropriate budget that enables the patient to pay all anticipated expenses arising from that insurable event or events directly to the providers, hospitals, and pharmacies of his choice 1095 with an electronic medical debit card, such as an electronic medical card containing encrypted keys that are to match with keys of the providers before money is transferred to pay the bills.

According to further exemplary embodiments, a communications device of a patient may include the HSA application and provide a graphical user interface that displays an image of the global budget and prospective and actual payments. For example, a global budget may be represented by a pie chart with 50% allocated to physician care, 25% to laboratory work and tests, and 25% for medication. If the patient selects a physician and each visit accounts for 5% of the global budget, then after six (6) visits the communications device displays a the pie chart with 30% missing from the 50% allocated towards physician visits. Such graphical display helps a patient make informed financial decisions when spending the global budget for medical care, treatment and medications for a diagnosis.

According to exemplary embodiments, the purpose of this invention is to create a detailed system to generate an appropriate prospective payment when certain insurable events occur. This invention replaces third party payment and procedure driven health care delivery that is that part of the current paradigm of health care financing that generates most of the reversible cost drivers and is causing rapid inflation of costs in our health care system.

According to some of the embodiments, this invention removes the poor incentives that exist in our current health care financing and delivery designs that contribute to health care cost inflation. It replaces them with good incentives with checks and balances to provide high quality care, at fair market prices, expands patient choice, while eliminating heath care cost inflation. This invention allows the health care providers the freedom to practice medicine, i.e., to diagnose and treat the patient within the context of appropriate care without uniformity, and offer the best quality care at the lowest price without being constrained by top down bureaucratic control necessary with today's insurance design. It also allows the insurance payment to be closely matched to any individual patient's particular medical needs and eliminates the need for third party rationing and price controls to control medical cost inflation.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A healthcare financing method, comprising:
associating a patient's medical record with a diagnosis, the diagnosis matched with a nondiscretionary insurable event, the diagnosis further matched with a protocol and complexity level associated with a primary morbidity, the protocol and complexity level further associated with at least one of a co-morbidity, a unique treatment requirement of the patient, and a local market factor;
analyzing the diagnosis to determine if there is a new nondiscretionary insurable event, and if there is a new nondiscretionary insurable event, then determining a lump sum payment of a global budget into a patient's health savings account, the patient's health savings account comprising one or more lump sum payments as well as other patient financial assets;
analyzing the diagnosis to determine if there is a new nondiscretionary insurable event, and if there is not a new nondiscretionary insurable event, then requesting authorization from a patient to make a prospective payment, the prospective payment withdrawn from the patient's health savings account.

2. The method of claim 1, further comprising:
transmitting the authorized prospective payment to a healthcare provider from the patient's health savings account.

3. The method of claim 1, further comprising:
accessing the health savings account for retrieving historical financial records, the historical financial records comprising at least one of a deposit of a lump sum payment associated with a diagnosis, payment of an authorized prospective payment, accumulation of interest, and other financial records.

4. The method of claim 1, wherein the health savings account further comprises health saving data comprising data associated with at least one of a diagnosis, patient information, geographic or local factor data, date of diagnosis, a medical or treatment record, and other financial data.

5. A method for providing health care coverage, comprising:
receiving protocol and complexity level data associated with a patient's diagnosis, the protocol and complexity level information associated with quantitative historical medical data associated with a medical condition of the patient's diagnosis including morbidity and co-morbidity data and with a global budget that collectively includes all forecasted payments for expenses associate with an insurable event priced according to one or more local market factors; and
using the protocol and complexity level data associated with a patient's diagnosis to create an patient's global budget for the patient's diagnosis; and
transmitting the patient's global budget to an asset account of the patient if there is a new insurable event.

6. The method of claim 5, further comprising:
not transmitting a global payment to the asset account of the patient if a new insurable event has not occurred 4. The method of claim 3, further comprising receiving premium payments from the patient's asset account.

7. A healthcare financing system comprising:
a computer-readable medium; and
operative instructions provided on the computer-readable medium comprising:
associating a patient's medical record with a diagnosis, the diagnosis matched with a nondiscretionary insurable event, the diagnosis further matched with a protocol and complexity level associated with a primary morbidity, the protocol and complexity level further associated with at least one of a co-morbidity, a unique treatment requirement of the patient, and a local market factor;
analyzing the diagnosis to determine if there is a new nondiscretionary insurable event, and if there is a new nondiscretionary insurable event, then determining a lump sum payment of a global budget into a patient's health savings account, the patient's health savings account comprising one or more lump sum payments as well as other patient financial assets;
analyzing the diagnosis to determine if there is a new nondiscretionary insurable event, and if there is not a new nondiscretionary insurable event, then requesting authorization from a patient to make a prospective payment, the prospective payment withdrawn from the patient's health savings account.

8. The system of claim 7, further comprising operative instructions comprising:
transmitting the authorized prospective payment to a healthcare provider.
accessing the health savings account for retrieving historical financial records, the historical financial records comprising at least one of a deposit of a lump sum payment associated with a diagnosis, payment of an authorized prospective payment, accumulation of interest, and other financial records.

9. The system of claim 7, the computer readable medium stored on a communications device.

10. The system of claim 9, the communications device comprising:
an iphone,
a remote control device,
a mobile phone,
a cellular phone,
a WAP phone,
a satellite phone,
a Voice over Internet Protocol phone,
a computer,
a modem,
a pager,
a personal digital assistant,
an interactive television,
a digital signal processor,
a set top box,
an appliance, and
a Global Positioning System device.

11. A device, comprising:
a processor in communication with a memory device to access and select one or more data files to present to the device, the data associated with the steps comprising:
associating a patient's medical record with a diagnosis, the diagnosis matched with a nondiscretionary insurable event, the diagnosis further matched with a protocol and complexity level associated with a primary morbidity, the protocol and complexity level further associated with at least one of a co-morbidity, a unique treatment requirement of the patient, and a local market factor,
analyzing the diagnosis to determine if there is a new nondiscretionary insurable event, and if there is a new nondiscretionary insurable event, then determining a lump sum payment of a global budget into a patient's health savings account, the patient's health savings account comprising one or more lump sum payments as well as other patient financial assets, and
analyzing the diagnosis to determine if there is a new nondiscretionary insurable event, and if there is not a new nondiscretionary insurable event, then requesting authorization from a patient to make a prospective payment, the prospective payment withdrawn from the patient's health savings account.

12. The device of claim 11, further comprising a graphical display for presenting a graphical image.

13. The device of claim 11, further comprising a speaker for presenting audio.

14. The device of claim 11, wherein the processor communicates with the memory device to access and select one or more data files to simultaneously present to the device.

15. The device of claim 11, further comprising:
a wireless transceiver for transmitting and receiving communications signals to a wireless device.

16. The device of claim 11, wherein the wireless device comprises at least one of:
an iphone,
a remote control device,
a mobile phone,
a cellular phone,
a WAP phone,
a satellite phone,
a Voice over Internet Protocol phone,
a computer,
a modem,
a pager,
a personal digital assistant,
an interactive television,
a digital signal processor,
a set top box,
an appliance, and
a Global Positioning System device.

17. The device of claim 11, further comprising:
a network connection for transmitting and receiving communications signals between the device and an external communications network.

18. The device of claim 11, wherein the external communications network comprises a communication services provider, the communications service provider processing a selection for presentation media to the device, and the communications service provider billing a user communications address.
